(19) United States
(12) Patent Application Publication
(10) Pub. No.: US 2021/0060674 A1
(43) Pub. Date: Mar. 4, 2021

(54) Tube Cutter with Lubricating Function

(71) Applicant: Bing-Cheng Liao, Taichung City (TW)

(72) Inventor: Bing-Cheng Liao, Taichung City (TW)

(21) Appl. No.: 16/861,310

(22) Filed: Apr. 29, 2020

(30) Foreign Application Priority Data
Aug. 30, 2019 (TW) 108211588

(51) Int. Cl. B23D 59/02; B23D 45/16

(52) U.S. Cl. CPC B23D 59/02; B23D 45/16

(57) ABSTRACT

A tube cutter includes a main body, a holder slidably mounted on the main body, a guide bolt rotatably mounted on the main body to move the holder, two rollers pivotally mounted on the main body, a cutting wheel rotatably mounted on the holder and corresponding to the rollers, and two pivot shafts extending through the main body and the rollers. Each of the pivot shafts has a periphery provided with at least one oil storage groove, and each of the rollers is radially provided with an oil filling hole corresponding to the at least one oil storage groove of each of the pivot shafts. Thus, lubricating oil is filled between each of the rollers and each of the pivot shafts to provide a lubricating function.

### BACKGROUND OF THE INVENTION

### 1. Field of the Invention

The present invention relates to a cutter and, more particularly, to a tube cutter for cutting a tube.

### 2. Description of the Related Art

A conventional tube cutter comprises a substantially U-shaped main body having a first end provided with a screw hole, a cutting wheel mounted on a second end of the main body, a slide movably mounted on the main body, two rollers mounted on the slide and aligning with the cutting wheel, and a threaded rod screwed through the screw hole of the main body and having a first end resting on the two rollers, and a control knob secured on a second end of the threaded rod. In operation, when the threaded rod is rotated by the control knob, the threaded rod is moved axially relative to the main body to drive the two rollers which drive the slide to move on the main body, so that the two rollers are moved relative to the cutting wheel. Thus, when the tube cutter is mounted on a tube or pipe, the two rollers rest on the tube. Then, the threaded rod is rotated by the control knob, and the two rollers are moved toward the cutting wheel, so that the tube is clamped between the two rollers and the cutting wheel. Then, the main body is held by the user's hand and is rotated relative to the tube, so that the cutting wheel is revolved on the tube so as to shear the tube gradually and successively until the tube is cut. However, the conventional tube cutter does not have an automatically feeding function so that the user has to rotate the control knob successively to move the two rollers to press the tube during the shearing process, thereby causing inconvenience to the user, and thereby wasting the energy and working time. In addition, the conventional tube cutter has a small torque so that the user has to apply a large force on the main body to rotate the main body is held by the user's hand and is rotated relative to the tube, so that the cutting wheel is revolved on the tube so as to shear the tube relative to the tube so as to shear the tube, thereby wasting the user's energy and time.

A conventional automatically feeding tube cutter in accordance with the prior art shown in FIG. 1 comprises a main body 60, a holder 70 slidably mounted on a first side of the main body 60, a guide bolt 80 rotatably mounted on the main body 60 and driving and moving the holder 70, two rollers 90 pivotally mounted on a second side of the main body 60, a cutting wheel 71 rotatably mounted on the holder 70 and corresponding to the two rollers 90, and two pivot shafts “Q” extending through the main body 60 and the two rollers 90. However, there is no lubricating oil provided between each of the two rollers 90 and each of the two pivot shafts “Q”, such that the two rollers 90 are easily locked or jammed and cannot be rotated freely during a long-term utilization. In addition, when a tube 1 to be cut is clamped between the two rollers 90 and the cutting wheel 71, pressed indentations are easily formed on the surface of the tube due to the friction between the two rollers 90 and the tube 1, thereby decreasing the aesthetic quality of the tube 1.

### BRIEF SUMMARY OF THE INVENTION

The primary objective of the present invention is to provide a tube cutter with a roller lubricating function.

In accordance with the present invention, there is provided a tube cutter comprising a main body, a holder slidably mounted on a first side of the main body, a guide bolt rotatably mounted on the main body and driving and moving the holder, two rollers pivotally mounted on a second side of the main body, a cutting wheel rotatably mounted on the holder and corresponding to the two rollers, and two pivot shafts extending through the main body and the two rollers.

In accordance with a first embodiment of the present invention, each of the two pivot shafts has a periphery provided with at least one oil storage groove, and each of the two rollers is radially provided with an oil filling hole corresponding to the at least one oil storage groove of each of the two pivot shafts.

In accordance with a second embodiment of the present invention, each of the two rollers has an inner diameter provided with at least one oil storage groove, and each of the two rollers is radially provided with an oil filling hole corresponding to the at least one oil storage groove.

In accordance with a third embodiment of the present invention, each of the two pivot shafts has a surface provided with at least one oil storage groove, and each of the two pivot shafts has an end provided with an oil filling hole corresponding to the oil storage groove.

According to the primary advantage of the present invention, the lubricating oil is filled between each of the two rollers and each of the two pivot shafts to provide a lubricating function, so as to reduce the friction between each of the two rollers and each of the two pivot shafts, such that the two rollers are rolled smoothly, thereby preventing the two rollers from leaving pressed indentations on the tube during operation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic operational view and a locally enlarged view of a conventional tube cutter in accordance with the prior art.

FIG. 2 is a perspective view of a tube cutter in accordance with the preferred embodiment of the present invention.

FIG. 3 is an exploded perspective view of the tube cutter as shown in

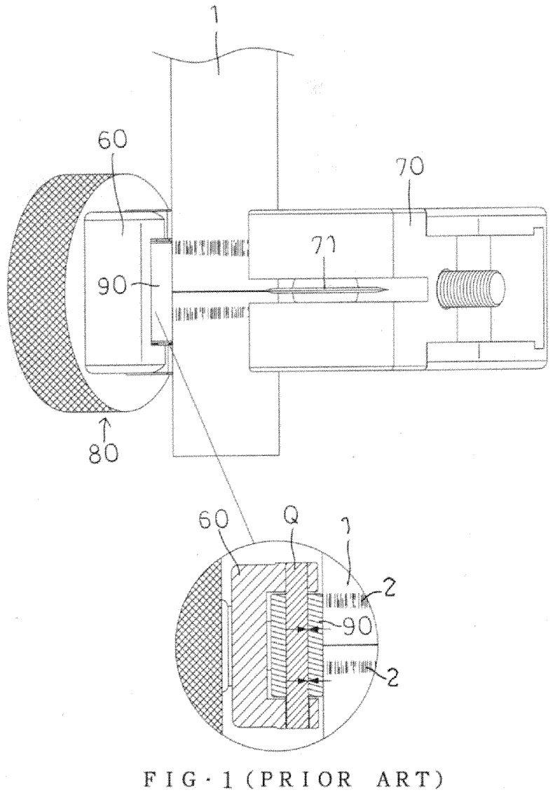

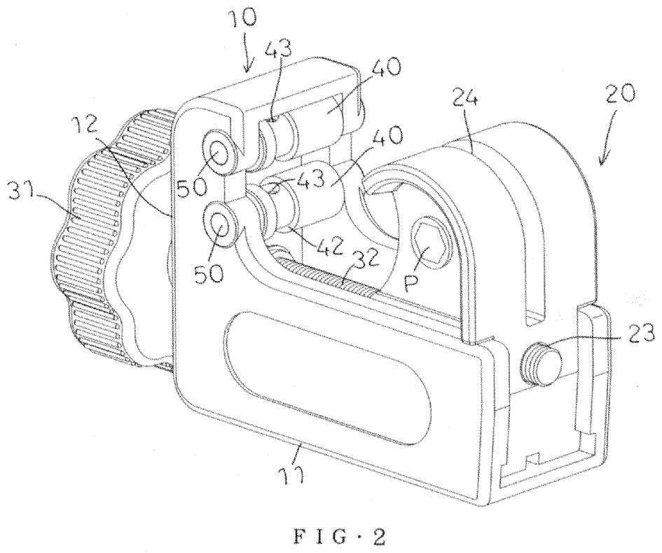

FIG. 2.

FIG. 4 is a perspective assembly view of a roller and a pivot shaft of the tube cutter in accordance with the first preferred embodiment of the present invention.

FIG. 5 is an exploded perspective view of the roller and the pivot shaft of the tube cutter as shown in FIG. 4.

FIG. 6 is a partially cross-sectional view showing an oil filling state of the tube cutter as shown in FIG. 4.

FIG. 7 is a cross-sectional operational view of the tube cutter as shown in FIG. 2.

FIG. 8 is a cross-sectional view of the tube cutter taken along line B-B as shown in FIG. 7.

FIG. 9 is a cross-sectional view of the tube cutter taken along line D-D as shown in FIG. 7.

FIG. 10 is a perspective assembly view of a roller and a pivot shaft of the tube cutter in accordance with the second preferred embodiment of the present invention.

FIG. 11 is an exploded perspective view of the roller and the pivot shaft of the tube cutter as shown in FIG. 10.

FIG. 12 is a partially cross-sectional view showing an oil filling state of the tube cutter as shown in FIG. 10.

FIG. 13 is a perspective assembly view of a roller and a pivot shaft of the tube cutter in accordance with the third preferred embodiment of the present invention.

FIG. 14 is an exploded perspective view of the roller and the pivot shaft of the tube cutter as shown in FIG. 13.

FIG. 15 is a partially cross-sectional view showing an oil filling state of the tube cutter as shown in FIG. 13.

FIG. 16 is a perspective assembly view of a roller and a pivot shaft of the tube cutter in accordance with the fourth preferred embodiment of the present invention.

FIG. 17 is an exploded perspective view of the roller and the pivot shaft of the tube cutter as shown in FIG. 16.

FIG. 18 is a partially cross-sectional view showing an oil filling state of the tube cutter as shown in FIG. 16.

FIG. 19 is a perspective assembly view of a roller and a pivot shaft of the tube cutter in accordance with the fifth preferred embodiment of the present invention.

FIG. 20 is an exploded perspective view of the roller and the pivot shaft of the tube cutter as shown in FIG. 19.

FIG. 21 is a partially cross-sectional view showing an oil filling state of the tube cutter as shown in FIG. 19.

FIG. 22 is a perspective assembly view of a roller and a pivot shaft of the tube cutter in accordance with the sixth preferred embodiment of the present invention.

FIG. 23 is an exploded perspective view of the roller and the pivot shaft of the tube cutter as shown in FIG. 22.

FIG. 24 is a partially cross-sectional view showing an oil filling state of the tube cutter as shown in FIG. 22.

### DETAILED DESCRIPTION OF THE INVENTION

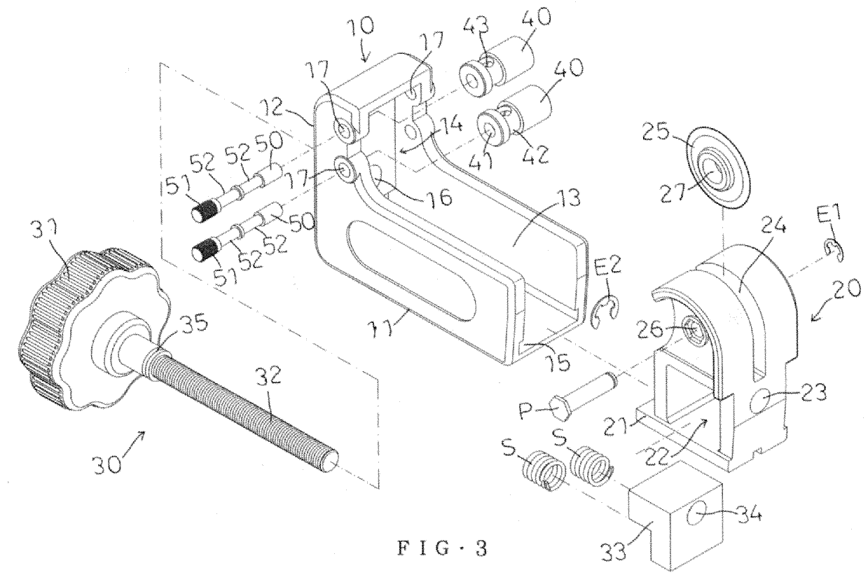

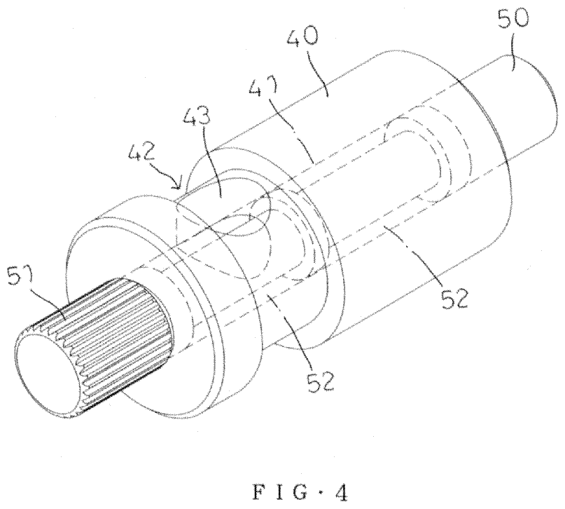

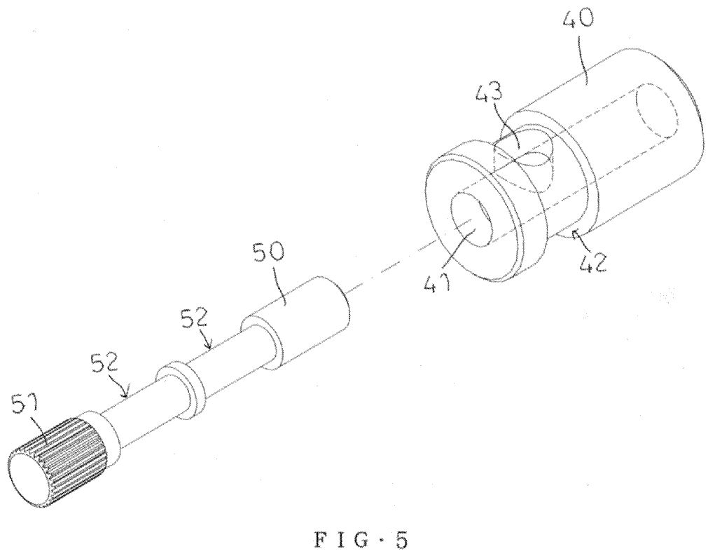

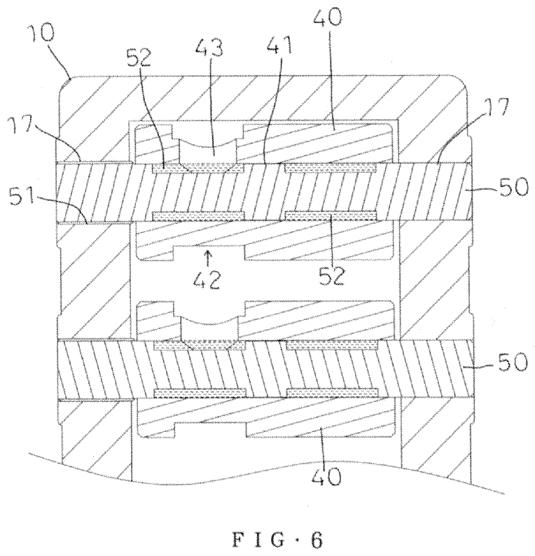

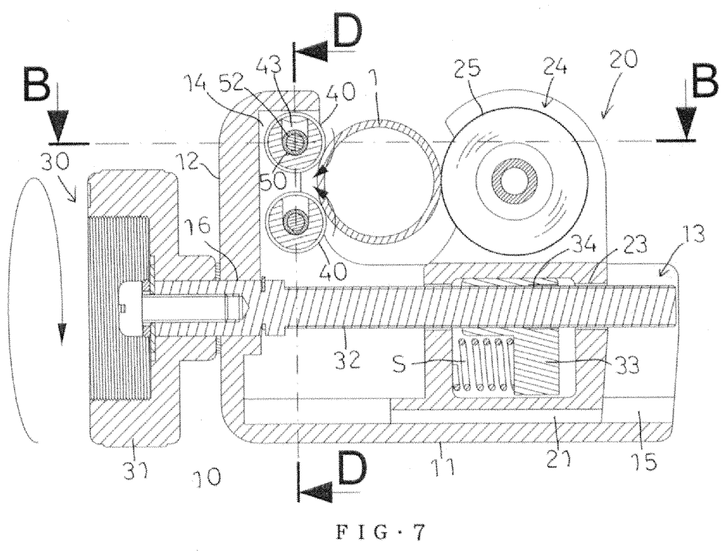

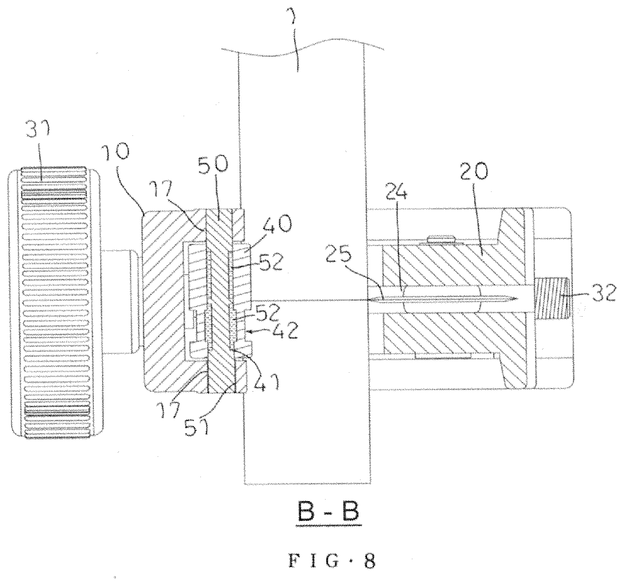

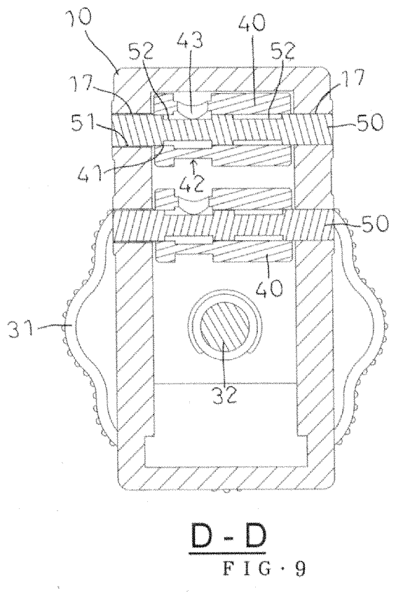

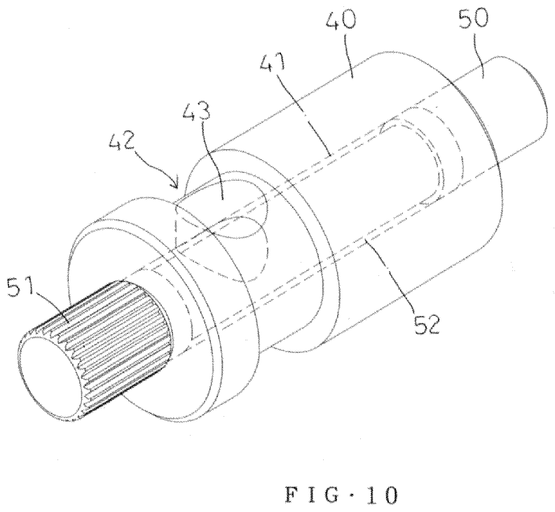

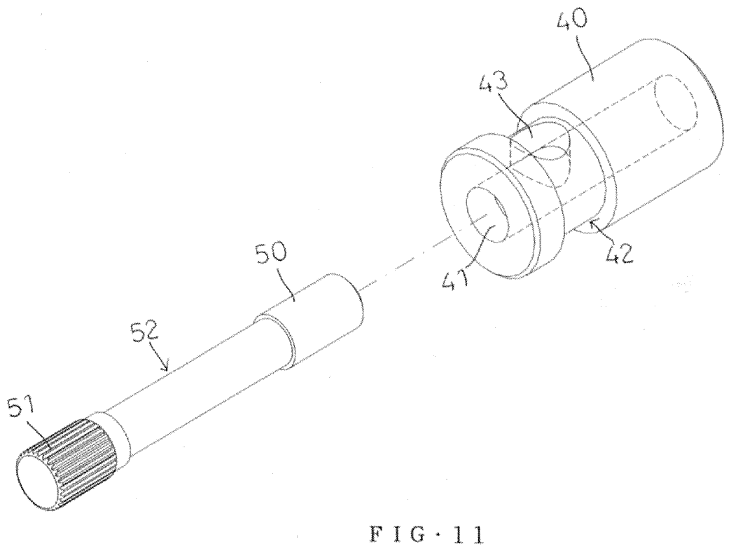

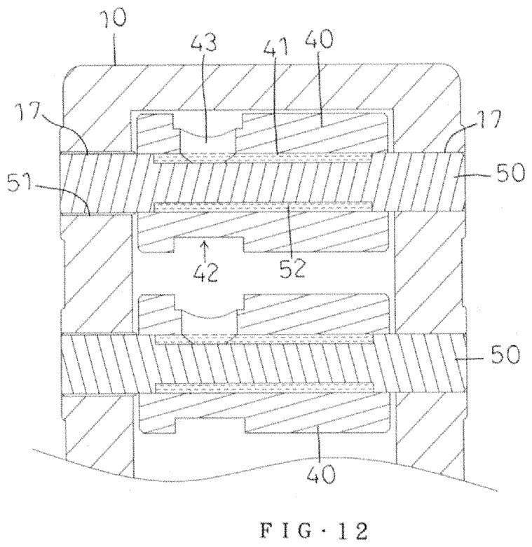

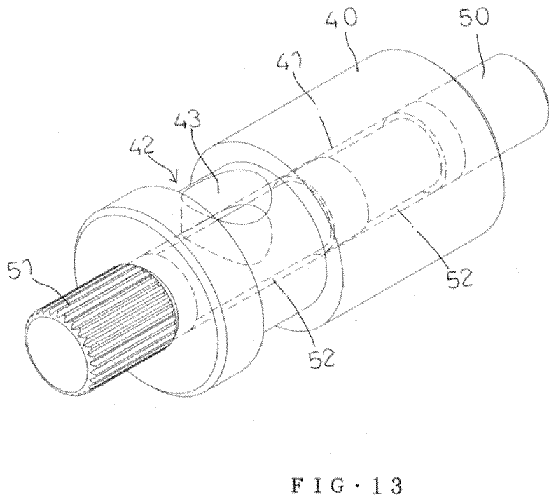

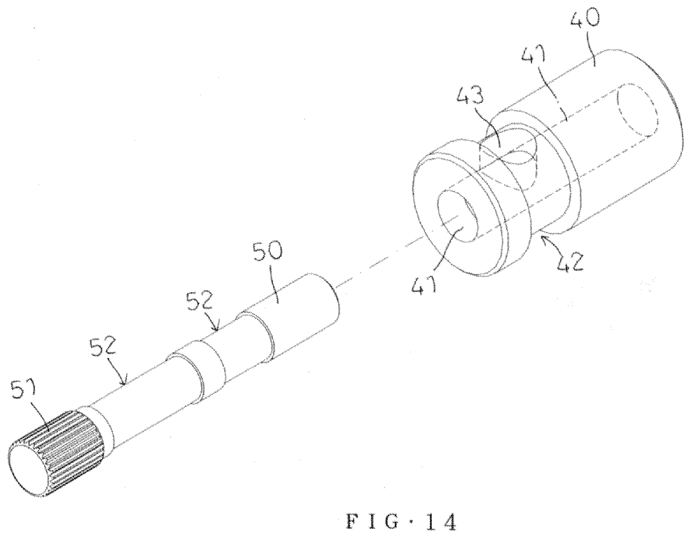

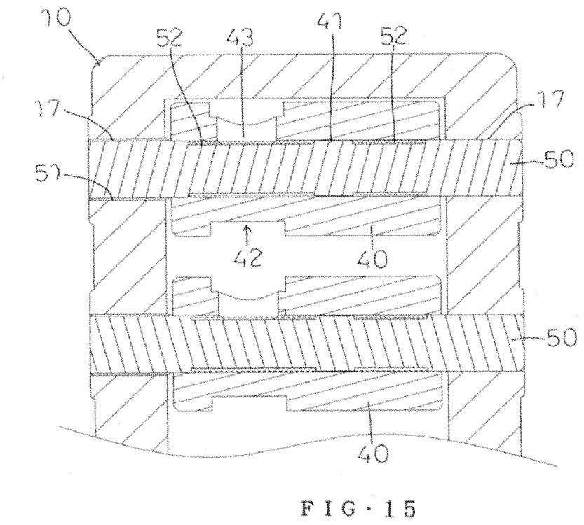

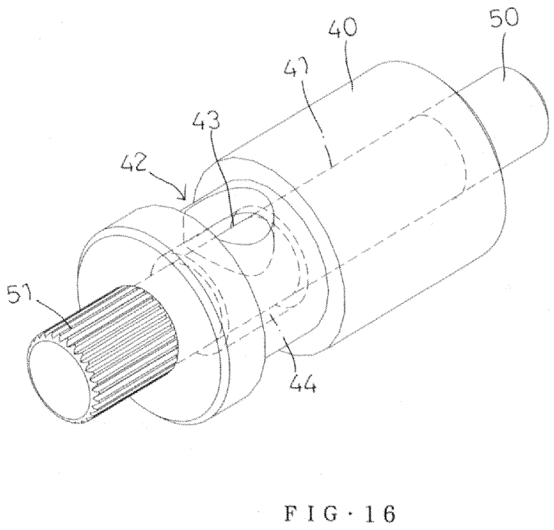

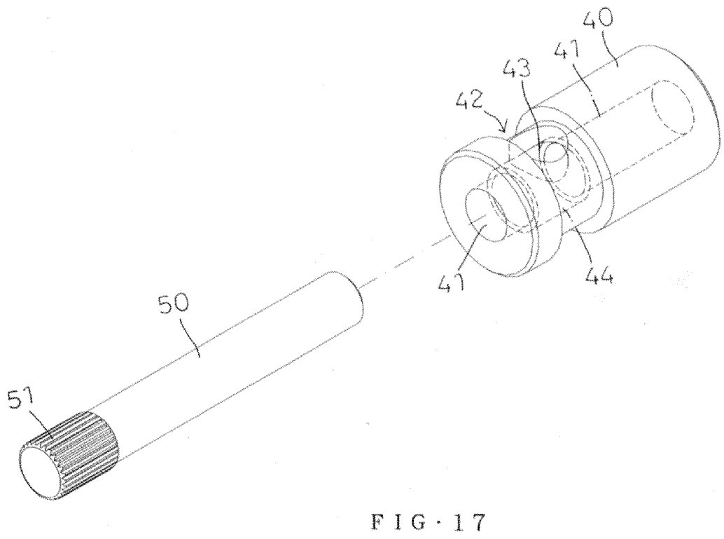

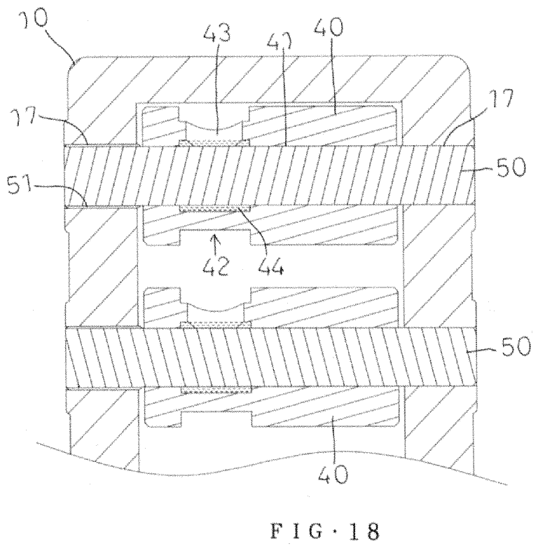

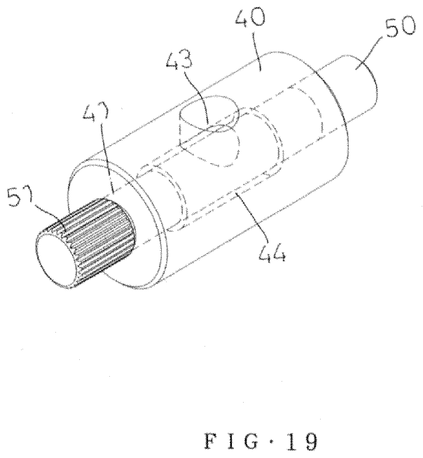

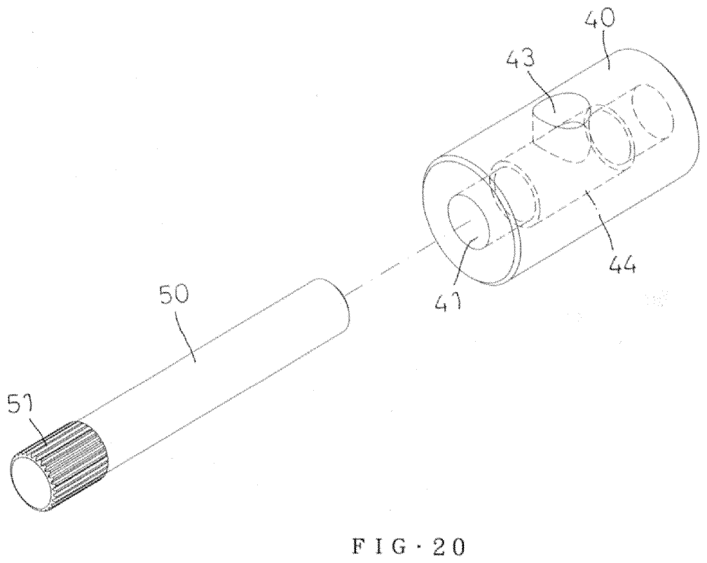

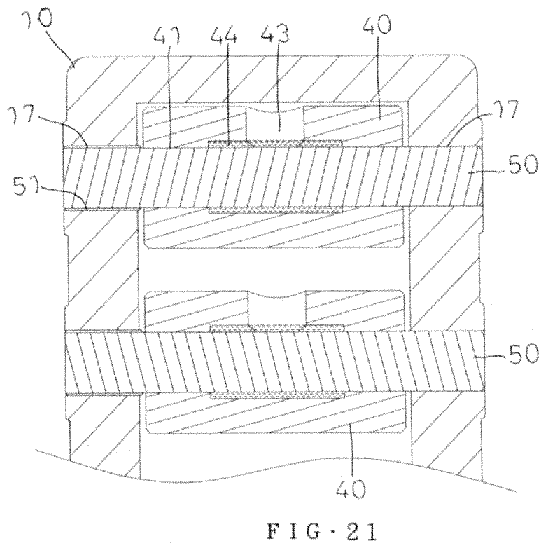

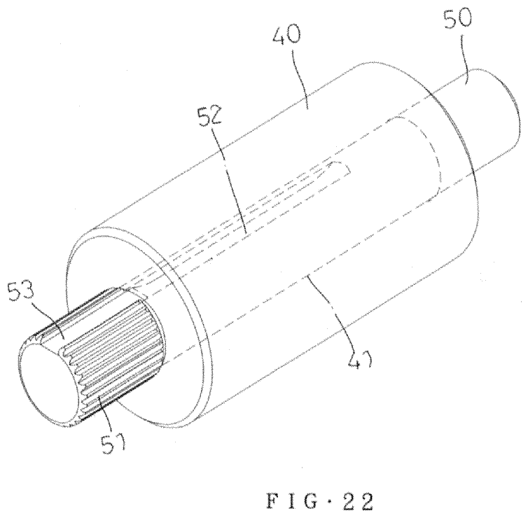

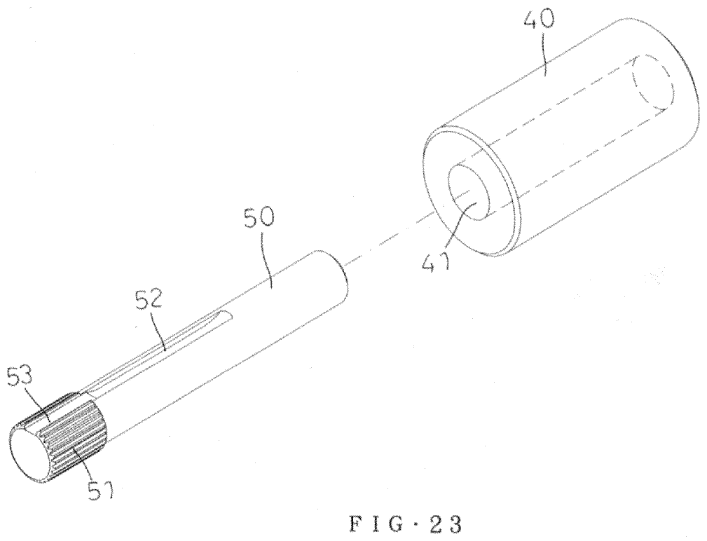

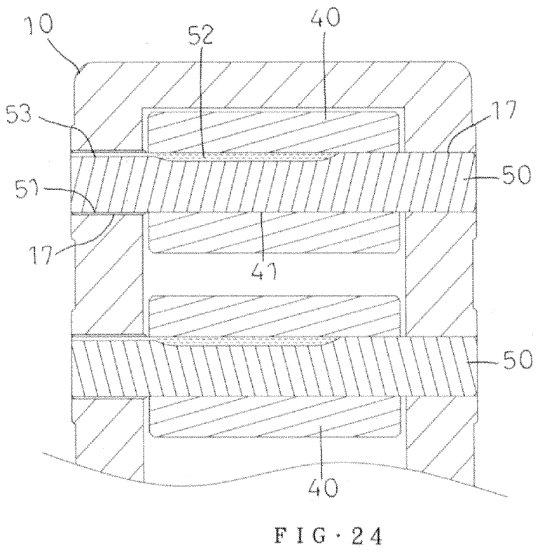

Referring to the drawings and initially to FIGS. 2-9, a tube cutter in accordance with the preferred embodiment of the present invention comprises a main body 10, a holder 20 slidably mounted on a first side of the main body 10, a slide 33 slidably mounted in the holder 20, a guide bolt 30 rotatably mounted on the main body 10, two rollers 40 pivotally mounted on a second side of the main body 10, a cutting wheel 25 rotatably mounted on the holder 20 and corresponding to the two rollers 40, and two pivot shafts 50 extending through the main body 10 and the two rollers 40.

The main body 10 is provided with a first through hole 16 corresponding to the holder 20 and allowing passage of the guide bolt 30. The holder 20 is provided with a receiving space 22 corresponding to the guide bolt 30. The holder 20 is provided with two second through holes 23 located at two sidewalls of the receiving space 22 and aligning with the first through hole 16 of the main body 10. The two second through holes 23 of the holder 20 allow passage of the guide bolt 30. The two rollers 40 are rotatably mounted on the main body 10 by the two pivot shafts 50. The slide 33 is received in the receiving space 22 of the holder 20 and has a height flush with that of the receiving space 22 as shown in FIG. 7. The slide 33 is provided with a screw hole 34. Two elastic members “S” are mounted in the receiving space 22 of the holder 20 and biased between the slide 33 and the holder 20. The guide bolt 30 extends through the main body 10, the holder 20, and the slide 33. The guide bolt 30 has a first end provided with a rotation portion 31 protruding from the first through hole 16 of the main body 10 and a second end provided with an external thread 32 screwed through the screw hole 34 of the slide 33. In assembly, the external thread 32 of the guide bolt 30 initially extends through the first through hole 16 of the main body 10 and a front one of the two second through holes 23 of the holder 20, is then screwed through the screw hole 34 of the slide 33, and then extends through a rear one of the two second through holes 23 of the holder 20.

In practice, the slide 33 is driven by rotation of the guide bolt 30 to drive and move the holder 20 forward or backward, while the holder 20 is pushed by an elastic force of the elastic members “S”, so that the cutting wheel 25 is fed toward the two rollers 40 automatically during a cutting process. In the preferred embodiment of the present invention, the main body 10 is provided with two slideways 15, and the holder 20 is provided with two slides 21 slidably mounted in the two slideways 15 of the main body 10 so that the holder 20 is moved forward or backward.

In the preferred embodiment of the present invention, the main body 10 has a substantially L-shaped profile and includes a horizontal portion 11 and a vertical portion 12 located at a side of the horizontal portion 11. The horizontal portion 11 of the main body 10 is provided with a horizontal receiving channel 13, and the vertical portion 12 of the main body 10 is provided with a vertical receiving channel 14. The two slideways 15 are formed in the horizontal portion 11 of the main body 10 and connected to the horizontal receiving channel 13. The first through hole 16 is formed in the vertical portion 12 of the main body 10. The holder 20 is slidably mounted in the horizontal receiving channel 13 of the main body 10 so that the holder 20 is moved forward or backward in the horizontal receiving channel 13 of the main body 10. The two rollers 40 are pivotally mounted in the vertical receiving channel 14 of the main body 10.

In the preferred embodiment of the present invention, the holder 20 is provided with an arcuate slot 24 corresponding between the two rollers 40, and the cutting wheel 25 is rotatably mounted in the slot 24 of the holder 20. The holder 20 is provided with two coaxial through bores 26 located at two sidewalls of the slot 24. The cutting wheel 25 is provided with an axial bore 27. A screw “P” extends through the two through bores 26 of the holder 20 and the axial bore 27 of the cutting wheel 25, and a snap ring “E1” is mounted on the screw “P”. Thus, the cutting wheel 25 is rotatable freely on the screw “P”.

In the preferred embodiment of the present invention, each of the two rollers 40 has a periphery provided with a receiving groove 42 to receive or avoid a protruding edge of a workpiece, such as a tube 1, to be cut.

In the preferred embodiment of the present invention, the guide bolt 30 has a mediate position provided with a retaining groove 35, and a snap ring “E2” is mounted in the retaining groove 35 to prevent the guide bolt 30 from being detached from the main body 10.

In the preferred embodiment of the present invention, the vertical receiving channel 14 of the main body 10 has two sidewalls each provided with two pivot holes 17. Each of the two rollers 40 is provided with a shaft hole 41. The two pivot shafts 50 extend through the pivot holes 17 of the main body 10 and the shaft holes 41 of the two rollers 40, so that the two rollers 40 are rotatable freely in the vertical receiving channel 14 of the main body 10.

In the preferred embodiment of the present invention, each of the two pivot shafts 50 has an end provided with a toothed portion 51 engaging an inner wall of one of the pivot holes 17 of the main body 10.

In the preferred embodiment of the present invention, each of the two pivot shafts 50 has a periphery provided with two oil storage grooves 52. Each of the two rollers 40 is radially provided with an oil filling hole 43 corresponding to the two oil storage grooves 52 of each of the two pivot shafts 50. The oil filling hole 43 of each of the two rollers 40 is connected to the shaft hole 41 and the two oil storage grooves 52 of each of the two pivot shafts 50. The two oil storage grooves 52 of each of the two pivot shafts 50 is connected to and fully received in the shaft hole 41 of each of the two rollers 40. Preferably, each of the two oil storage grooves 52 of each of the two pivot shafts 50 has an annular shape, a straight shape, an oblique shape or a helical shape.

Thus, lubricating oil is filled through the oil filling hole 43 of each of the two rollers 40 into the two oil storage grooves 52 of each of the two pivot shafts 50 to provide a lubricating function, and to reduce a friction between each of the two rollers 40 and each of the two pivot shafts 50, such that the two rollers 40 are rolled smoothly, thereby preventing the two rollers 40 from forming a pressed indentation on the tube 1 to be cut.

In operation, referring to FIGS. 7-9 with reference to FIGS. 2-6, when the tube cutter is used to shear a workpiece, such as a tube 1, the tube 1 is inserted between the two rollers 40 and the cutting wheel 25 as shown in FIG. 7, so that the two rollers 40 and the cutting wheel 25 are under a three-point contact condition to support the tube 1 steadily. At this time, the holder 20 is pressed by the tube 1 to compress the elastic members “S”. Then, the main body 10 and the holder 20 are held by the user's fingers and are rotated relative to the tube 1, so that the cutting wheel 25 is revolved on the tube 1 reciprocally so as to shear the tube 1 gradually and successively until the tube 1 is cut. At this time, the holder 20 is pushed toward the tube 1 by the elastic force of the elastic members “S”, so that the cutting wheel 25 is fed toward the tube 1 automatically during the cutting process, so as to tightly engage and shear the tube 1 successively according to the thickness of the tube 1.

It is appreciated that, the external thread 32 of the guide bolt 30 is screwed into the screw hole 34 of the slide 33, so that when the guide bolt 30 is rotated by the rotation portion 31, the slide 33 is displaced in the receiving space 22 of the holder 20, and is moved forward or backward to compress or loosen the elastic members “S”, so as to regulate the tension and restore the elastic force of the elastic members “S”. In such a manner, the elastic force of the elastic members “S” is regulated by rotation of the guide bolt 30 so as to correspond to and match the thickness of the tube 1, so that the cutting wheel 25 engages the tube 1 closely and tightly. For example, when the rotation portion 31 of the guide bolt 30 is rotated clockwise, the slide 33 is moved forward to compress the elastic members “S”, so as to increase the elastic force of the elastic members “S”, and when the rotation portion 31 of the guide bolt 30 is rotated anticlockwise, the slide 33 is moved backward to loosen the elastic members “S”, so as to decrease the elastic force of the elastic members “S”.

Accordingly, the holder 20 is pushed by the elastic force of the elastic members “S”, so that the cutting wheel 25 is fed toward the tube 50 automatically during the cutting process, so as to shear the tube 50 successively until the tube 50 is cut, thereby facilitating the user operating the tube cutter when cutting the tube 50. In addition, the lubricating oil is filled between each of the two rollers 40 and each of the two pivot shafts 50 to provide a lubricating function, so as to reduce the friction between each of the two rollers 40 and each of the two pivot shafts 50, such that the two rollers 40 are rolled smoothly, thereby preventing the two rollers 40 from leaving pressed indentations on the tube 1 during operation.

Referring to FIGS. 10-12, each of the two pivot shafts 50 has a periphery provided with an oil storage groove 52. Each of the two rollers 40 is radially provided with an oil filling hole 43 corresponding to the oil storage groove 52 of each of the two pivot shafts 50. Thus, the lubricating oil is filled through the oil filling hole 43 of each of the two rollers 40 into the oil storage groove 52 of each of the two pivot shafts 50 to provide a lubricating function, and to reduce the friction between each of the two rollers 40 and each of the two pivot shafts 50, such that the two rollers 40 are rolled smoothly, thereby preventing the two rollers 40 from forming a pressed indentation on the tube 1.

Referring to FIGS. 13-15, each of the two pivot shafts 50 has a periphery provided with two oil storage grooves 52 with different dimensions. Each of the two rollers 40 is radially provided with an oil filling hole 43 corresponding to the two oil storage grooves 52 of each of the two pivot shafts 50. Thus, the lubricating oil is filled through the oil filling hole 43 of each of the two rollers 40 into the two oil storage grooves 52 of each of the two pivot shafts 50 to provide a lubricating function, and to reduce the friction between each of the two rollers 40 and each of the two pivot shafts 50, such that the two rollers 40 are rolled smoothly, thereby preventing the two rollers 40 from forming a pressed indentation on the tube 1.

Referring to FIGS. 16-18, the shaft hole 41 of each of the two rollers 40 has a periphery provided with an oil storage groove 44 corresponding to the receiving groove 42. Each of the two rollers 40 is radially provided with an oil filling hole 43 corresponding to the oil storage groove 44. The oil filling hole 43 of each of the two rollers 40 is connected to the shaft hole 41 and the oil storage groove 44. Preferably, the oil storage groove 44 of each of the two rollers 40 has an annular shape, a straight shape, an oblique shape or a helical shape. Thus, the lubricating oil is filled through the oil filling hole 43 of each of the two rollers 40 into the oil storage groove 44 to provide a lubricating function, and to reduce the friction between each of the two rollers 40 and each of the two pivot shafts 50, such that the two rollers 40 are rolled smoothly, thereby preventing the two rollers 40 from forming a pressed indentation on the tube 1.

Referring to FIGS. 19-21, the shaft hole 41 of each of the two rollers 40 has a periphery having a middle provided with an oil storage groove 44. Each of the two rollers 40 is radially provided with an oil filling hole 43 corresponding to the oil storage groove 44. Thus, the lubricating oil is filled through the oil filling hole 43 of each of the two rollers 40 into the oil storage groove 44 to provide a lubricating function, and to reduce the friction between each of the two rollers 40 and each of the two pivot shafts 50, such that the two rollers 40 are rolled smoothly, thereby preventing the two rollers 40 from forming a pressed indentation on the tube 1.

Referring to FIGS. 22-24, each of the two pivot shafts 50 has a surface provided with an oil storage groove 52. The oil storage groove 52 has an elongate shape and extends longitudinally along each of the two pivot shafts 50. The oil storage groove 52 of each of the two pivot shafts 50 is connected to the shaft hole 41 of each of the two rollers 40. Each of the two pivot shafts 50 has an end provided with an oil filling hole 53 corresponding to the oil storage groove 52. The oil filling hole 53 extends longitudinally along each of the two pivot shafts 50 and is connected to the oil storage groove 52. The oil filling hole 53 of each of the two pivot shafts 50 protrudes outward from the shaft hole 41 of each of the two rollers 40. Thus, the lubricating oil is filled through the oil filling hole 53 of each of the two pivot shafts 50 into the oil filling hole 53 to provide a lubricating function, and to reduce the friction between each of the two rollers 40 and each of the two pivot shafts 50, such that the two rollers 40 are rolled smoothly, thereby preventing the two rollers 40 from forming a pressed indentation on the tube 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A tube cutter comprising:
a main body;
a holder slidably mounted on a first side of the main body;
a guide bolt rotatably mounted on the main body and driving and moving the holder;
two rollers pivotally mounted on a second side of the main body;
a cutting wheel rotatably mounted on the holder and corresponding to the two rollers; and
two pivot shafts extending through the main body and the two rollers;
wherein:
each of the two pivot shafts has a periphery provided with at least one oil storage groove; and
each of the two rollers is radially provided with an oil filling hole corresponding to the at least one oil storage groove of each of the two pivot shafts.

2. The tube cutter as claimed in claim 1, wherein:
each of the two rollers is provided with a shaft hole;
each of the two pivot shafts extends through the shaft hole of each of the two rollers; and
the oil filling hole of each of the two rollers is connected to the shaft hole.

3. A tube cutter comprising:
a main body;
a holder slidably mounted on a first side of the main body;
a guide bolt rotatably mounted on the main body and driving and moving the holder;
two rollers pivotally mounted on a second side of the main body;
a cutting wheel rotatably mounted on the holder and corresponding to the two rollers; and
two pivot shafts extending through the main body and the two rollers;
wherein:
each of the two rollers has an inner diameter provided with at least one oil storage groove; and
each of the two rollers is radially provided with an oil filling hole corresponding to the at least one oil storage groove.

4. The tube cutter as claimed in claim 3, wherein:
each of the two rollers is provided with a shaft hole;
the shaft hole of each of the two rollers is connected to the at least one oil storage groove;
each of the two pivot shafts extends through the shaft hole of each of the two rollers; and
the oil filling hole of each of the two rollers is connected to the shaft hole.

5. A tube cutter comprising:
a main body;
a holder slidably mounted on a first side of the main body;
a guide bolt rotatably mounted on the main body and driving and moving the holder;
two rollers pivotally mounted on a second side of the main body;
a cutting wheel rotatably mounted on the holder and corresponding to the two rollers; and
two pivot shafts extending through the main body and the two rollers;
wherein:
each of the two pivot shafts has a surface provided with at least one oil storage groove; and
each of the two pivot shafts has an end provided with an oil filling hole corresponding to the oil storage groove.

6. The tube cutter as claimed in claim 5, wherein:
the oil storage groove has an elongate shape and extends longitudinally along each of the two pivot shafts; and
the oil filling hole extends longitudinally along each of the two pivot shafts.

7. The tube cutter as claimed in claim 5, wherein:
each of the two rollers is provided with a shaft hole;
each of the two pivot shafts extends through the shaft hole of each of the two rollers; and
the oil storage groove of each of the two pivot shafts is connected to the shaft hole of each of the two rollers.
